(19) United States
(12) Patent Application Publication
(10) Pub. No.: US 2022/0038431 A1
(43) Pub. Date: Feb. 3, 2022

(54) A Secure Multi-Layered Infrastructure Monitoring and Remote Connectivity System and Method

(71) Applicant: Mark Macy, Ottawa (CA)

(72) Inventor: Mark Macy, Ottawa (CA)

(21) Appl. No.: 17/278,636

(22) PCT Filed: Sep. 23, 2019
(86) PCT No.: PCT/CA2019/051356

§ 371 Date: Mar. 22, 2021

Related U.S. Application Data
(60) Provisional application No. 62/734,465, filed on Sep. 21, 2018.

(51) Int. Cl. H04L 29/06; G08B 25/08; H04W 12/033; H04W 12/086

(52) U.S. Cl. CPC H04L 63/0272; H04W 12/086; H04W 12/033; G08B 25/08

(57) ABSTRACT

The present disclosure relates to the management of building properties such as commercial office towers, shopping centers, multi-unit residential properties, individual dwellings, government and industrial complexes, utilities, schools and 5 school campuses, etc. The disclosed system and method provides a secure access control device which enables external users to access operating technology devices such as for example video cameras, elevator control, security systems, fire safety systems, securely through a cellular private network. Users of the system can also share links to access content associate with the property.

### CROSS-REFERENCE TO RELATED APPLICATIONS

This application claims priority from U.S. Provisional Application No. 62/734,465 filed Sep. 21, 2018, the entirety is hereby incorporated by reference for all purposes.

### TECHNICAL FIELD

The present disclosure relates to remote monitoring and in particular to providing secure remote monitoring of infrastructure components for property and facility management.

### BACKGROUND

As digital infrastructure used to monitor and control properties and facilities increases the ability to access and remotely monitor remote has increased. Operating technologies such as fire and intrusion alarm monitoring panels, building automation systems and heating ,ventilation and air conditioning (HVAC), elevator entrapment phones, payment kiosks for parking and laundry, building entry phones, utility meters, access control systems, thermostats, lights, etc., and video surveillance systems (VSS) and closed circuit television (CCTV). However, these operational technologies present a greater attack service and expose vulnerabilities within the building infrastructure. Existing solutions provide protection to each individual system making access cumbersome and inconsistent.

Accordingly, systems and methods that enable secure, remote connectivity to building operating technologies remains highly desirable.

### BRIEF DESCRIPTION OF THE DRAWINGS

Further features and advantages of the present disclosure will become apparent from the following detailed description, taken in combination with the appended drawings, in which:

FIG. 1 shows a representation of system for secure remote connectivity;

FIG. 2 shows a representation of a method for secure remote connectivity;

FIG. 3 shows a representation of a method of video processing for secure remote connectivity;

FIG. 4 shows a representation of secured multilayered monitoring system for secure remote connectivity with an access control device;

FIG. 5 shows a representation of a secured multilayered monitoring system exemplary message flow with an access control device;

FIG. 6 shows a representation of a secured multilayered monitoring system for secure remote connectivity between networks with an access control device; and

FIG. 7 shows a representation of a method of forwarding OT device data to additional remote devices.

It will be noted that throughout the appended drawings, like features are identified by like reference numerals.

### DETAILED DESCRIPTION

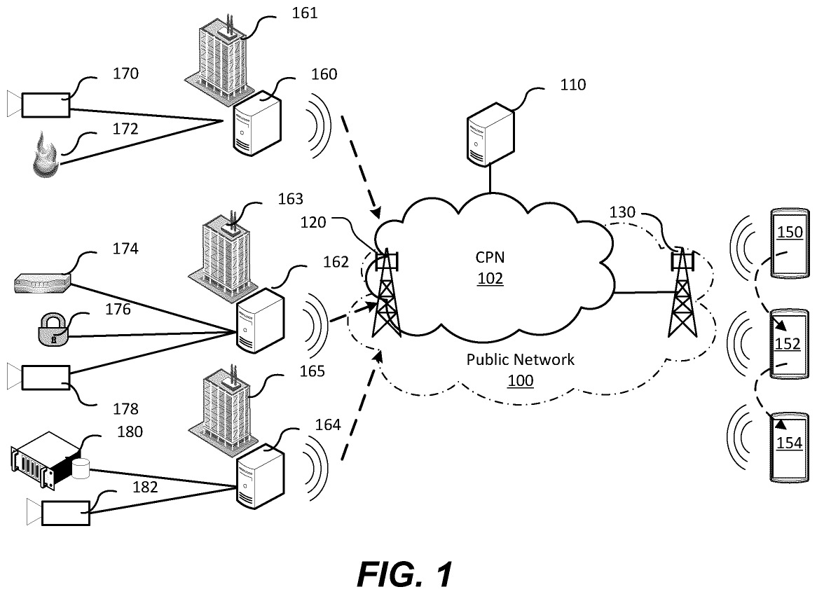

Embodiments are described below, by way of example only, with reference to FIGS. 1-7.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system and method for secure access to property operating technology devices, the method including: receiving a request to access OT devices associated with the property from a user device coupled to the public data network; verifying credentials associated with the user originating the request; establishing a secure cellular private network (CPN) connection over the cellular wireless network to an access control device located at the property; receiving a OT device data from the access control device; encrypting the OT device data from the access control device; and forwarding the encrypted OT device data to the user device. Other embodiments of this aspect include corresponding computer systems, apparatus, and computer programs recorded on one or more computer storage devices, each configured to perform the actions of the methods.

Implementations may include one or more of the following features. The method where the OT devices is selected from a group including access control devices, network video cameras (NVR), heating ventilation and air conditioning (HVAC), elevator monitoring, alarm panels; and building access system. The method where the CPN is defined by a subnet on the cellular wireless network. The method where the subnet is encrypted. The method further including: generating a sharing request from the user to a subsequent user/service to access data associated with the one or more OT devices; determining the access rights of the user; providing access to the requested devices if the user has appropriate access rights or limiting access of the user if they do not have appropriate access rights. The method where the OT device data is a video data, the video data is transcoded prior to encryption. The method where the access control device is connected to the cellular network by 3G, 4G LTE or 5G access technologies. The method where the CPN is initiated upon a request from a user. The method where a pre-existing CPN is utilized upon a subsequent request from a user. The method where the OT device data is forwarded to an emergency service based upon the request from the user device. The method where the emergency service is fire, police or ambulance. The method where the method is executed at a datacenter coupled to the cellular network. The method where the property a commercial office towers, shopping centers, multi-unit residential properties, individual dwellings, government and industrial complexes, utilities, schools and school campuses. The method where the encryption is one of AES, DES, RSA, or two-fish encryption schemes. The method where the access control device is a site proxy device. Implementations of the described techniques may include hardware, a method or process, or computer software on a computer-accessible medium.

One general aspect includes a system for remote monitoring of a property, the system including: a cellular private network connection a plurality of properties; a plurality of access control devices at each of the plurality of properties, each access control device including:. The system also includes a processor. The system also includes a memory. The system also includes a network interface coupled to operating technology (OT) devices associated with the property. The system also includes a wireless cellular network interface device connected to the cellular private network. The system also includes a video processing device for processing video received from an operating technology device associated with a property. Other embodiments of this aspect include corresponding computer systems, apparatus, and computer programs recorded on one or more computer storage devices, each configured to perform the actions of the methods.

One general aspect includes a method for remote monitoring of a property, the method including: receiving a user access request at an access control device associated with a property; determining the user access rights for the user associated with the request; and providing access to one or more operating technology devices associated with the access control device and the property to the user. Other embodiments of this aspect include corresponding computer systems, apparatus, and computer programs recorded on one or more computer storage devices, each configured to perform the actions of the methods.

Implementations may include one or more of the following features. The method further including: generating a sharing request from the user to a subsequent user to access data associated with the one or more operating technology devices, determining the access rights of the user, providing access to the requested devices if the user has appropriate access rights or limiting access of the user if they do not have appropriate access rights. The method further including: receiving a video stream associated with the property from the access control device, analyzing the video stream to determine patterns based upon times of day, receiving a subsequent live video stream, determining variances with in the live video stream based upon the determined patterns. Implementations of the described techniques may include hardware, a method or process, or computer software on a computer-accessible medium.

Efficiency is a must have in today's competitive business world. It is why real world business processes are leveraging the connectivity offered by the Internet. The convergence of real world and the cyber world is where we are most vulnerable. The greater our commitment to technology, the greater our vulnerability.

Referring to FIG. 1, in order to provide a secure means of accessing building or property operating technologies a secure private network using wireless infrastructure 120, 130 is utilized by a cellular private network (CPN) 102, or secure private network (SPN) generated within a cellular/mobile carrier's wireless network 100. The building or property such as commercial office towers, shopping centers, multi-unit residential properties, individual dwellings, government and industrial complexes, utilities, schools and school campuses, etc. can be remotely accessed for monitoring and management.

The cellular or mobile private network (CPN) utilize wireless networking technologies such as 3G, 4G LTE and 5G. The CPN is not visible to the general users of the cellular network and can being essentially concealed to provide further security and access is provided through multilayered secure encryption. Machine-to-machine communication is provided via sub-nets which are not exposed to the Internet and are isolated to the general public wireless network on the IP core side of the Mobile Network Carrier. Access control devices 160, 162, 164 at the building/facility property 161, 163, 165 provides dynamic name service (DNS) and network address translation (NAT) functions for the on-property devices to the cellular private network to private secure operations datacenter 110. In addition the access control device provides a firewall and can act as a gateway to the datacenter 110. For video gateway applications the access control device can provide pattern recognition to identify different patterns during the various times of day within the building or external to the building and generate alerts when those patterns change. The external client devices such as smart phones, tablets or PCs 150, 152, 154 can access the private network by a location specific IP address which allows the establishment of a secure connection with the access control device. To further control the access to the information related to the building site a remote server may be utilized to manage encryption key access and user control.

The system provides secure, remote connectivity to all building operating technologies, regardless of manufacturer, and protects them from cyber threats. The system improves building operating technology (OT) security while retiring existing phone lines and Internet connections, reducing operating costs. For example access to OT devices 170-182 such as fire and intrusion alarm monitoring panels, building automation systems and HVAC, elevator entrapment phones, payment kiosks for parking and laundry, building entry phones, utility meters, access control systems, thermostats, lights, etc., and VSS & CCTV are provided by one central access point. The connection between the operations datacenter 110 and the access devices can be communicated by Multiprotocol Label Switching (MPLS) to route data from one node to the next based on short path labels rather than long network addresses.

The access control devices do not reside on the public facing Internet. The devices operate on the infrastructure of mobile network carriers, and provides priority access to their network. The access control box provides access to a secure private network behind a firewall which is updated in real time when malicious codes are identified. The access control devices communicate with a control system providing GDPR and ISO 27001 Information Security Management System (ISMS) Compliance.

Video management may also be provided in external data centre to enable processing of the video content and identification of any pertinent events.

When accessing information from the particular building site a user enters or selects a location to which they have access to on the secure network via an application or browser. The user can then connect to devices within the facility and access for example video streams of this facility via an encrypted connection such as a virtual private network (VPN). The user can then share the video streams using access privileges where in the first user can share the stream to a limited number of subsequent users and assume that those users are authorized to access the content. The user may for example share the link with an emergency services dispatch such as 911, 112, 999 which would then provide direct access to the OT device data such as video, alarm conditions, fire suppression systems etc. The link that is provided can have an inherent expiration. To which the user can no longer access the OT device data and content. In addition upon forwarding the link if the user has not been previously verified their access to control devices or view particular content at the location may be limited.

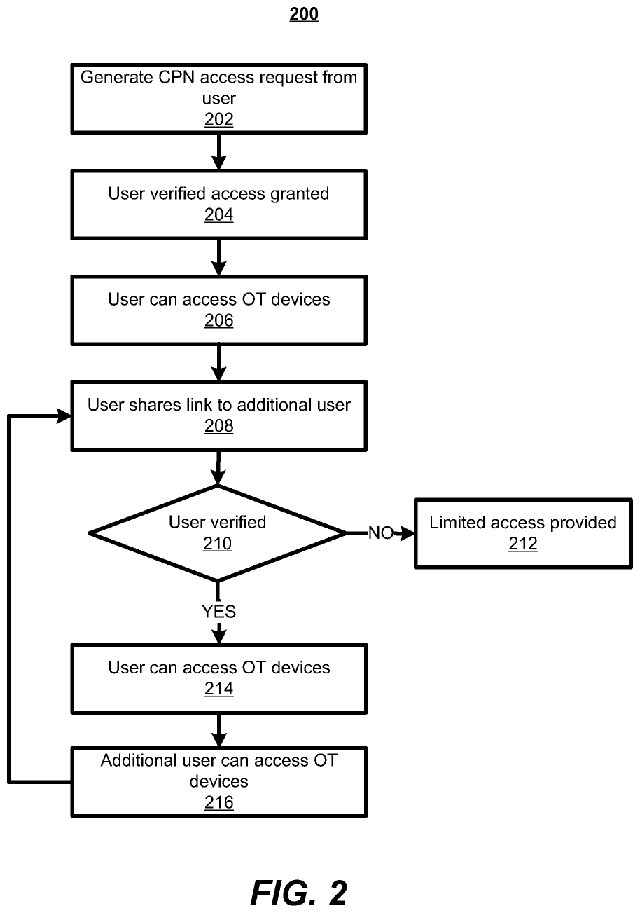

FIG. 2 shows a representation of a method 200 for secure remote connectivity. A cellular private network (CPN) access request is generated from a user device (202). The requests may have the direct private network address or may be translated through an intermediary gateway to be directed onto the CPN. The user associated with the access request can then be verified to determine their credentials and access rights (204). The user can then access the operating technology devices at the property based upon their access rights securely through the CPN network (206). The user may then share a link associated with the property to additional users that may or may not be previously verified by the system (208). If the user that the link was sent to is verified (YES at 210) the user can then access OT devices (214). The link may then be shared with further users or services either by the primary user or the subsequent user to provide access (216). The number of times that a link may be forwarded may be limited based upon capacity of the access controller to process those requests in a timely manner. In addition the primary user may be able to disconnect or restrict subsequent users that are connected. When the user is verified (NO at 210) and they are not an authorized registered user the OT devices that they can view or access may be limited (212) based upon default parameters in addition they may not be able to control any particular device.

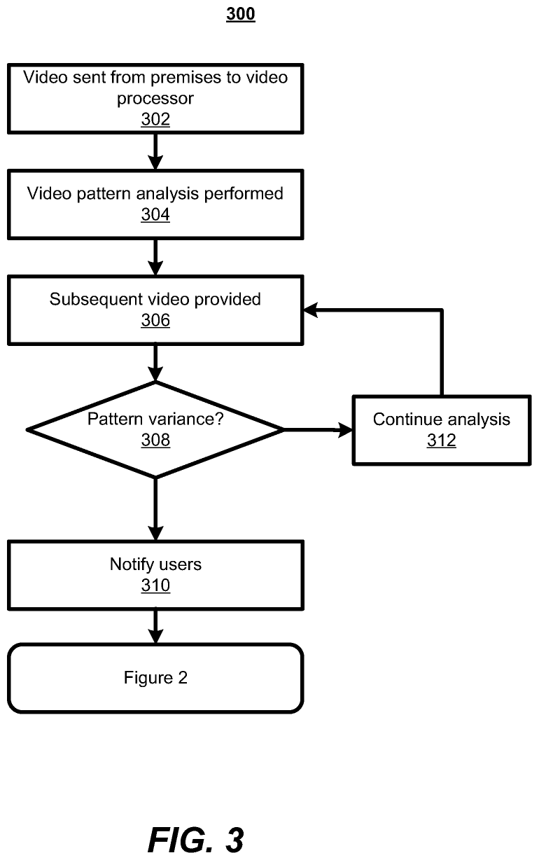

FIG. 3 shows a representation of a method 300 of video processing for secure remote connectivity. A video stream is sent from the property to a video processor (302). Video pattern analysis can then be performed based upon a time of day pattern recognition (304). Once patterns are identified for the particular video feed subsequent video streams may be provided (306) to identify any variance from a particular identified pattern. If no variance is identified (NO at 308) analysis continues (312). If a pattern variance is identified (YES at 308) users can then be notified (310) or a general alert generated potentially based upon the variance of the pattern change. Users then made for notifications to other users as described in FIG. 2.

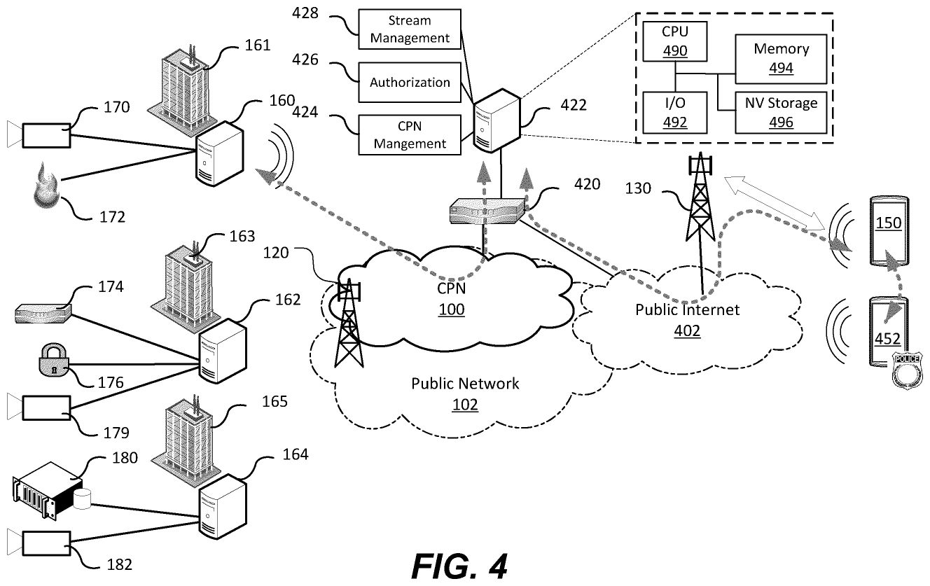

FIG. 4 shows an alternative representation of a system for secure remote connectivity from a building or property utilizing a secure private network using wireless infrastructure 120, 130 is utilized by a CPN 102 generated within a cellular carrier's wireless network 100. When the client device 150 would like to access the OT device data associated with the property 161 a request is originated from the device through a public cellular network which may transit the public Internet 402 to the secure utility access gateway device 420. Encryption is used between the gateway device 420 and the client device 150 as the connection is transiting public data networks and is routed by dedicated MPLS routing. A gateway device 420 provides access to a datacenter server(s) 422 which provides functionality for CPN management 424 to establish CPN connections, authorization functionality 426 to verify the credentials of the client device 150 or associated user and can determine if they can access OT device data associated with the property 161, based upon associated access permissions access or security levels, network access type, or the type of device used by the user. For example, a mobile device may not have access to a live video stream rather processed still images may be provided, or only certain facility systems may be accessed through a mobile device as opposed to a desktop interface. The datacenter provides Tier 3 or Tier 4 redundancy and fault-tolerance.

The authorization functionality 426 can then determine if the processing server has a pre-existing connection with the associated building/facility property 161. If a connection does not currently exist the gateway device 420 can then initiate a CPN 102 connection through a defined wireless network 100 to the associated secure access control device 160. The wireless private network, CPN 102, is separated and independent from the public Internet 402 and possibly defined as a secure subnet on a larger cellular network. The access control device 160 can then access the OT device data associated with one or more OT devices for example video camera 170 and may pre-process or filter the OT device data before providing a back to the stream management/processing functionality 428. The stream management 428 may then store or transcode the data or OT device data which can be presented back to the client device 150. The client device 150 may then initiate a forwarding access requests to a secondary device or emergency services 152 such as 911, 999, etc. where appropriate authorization is provided.

The secure access control devices 160, 162, 164, gateway 420 authorization functionality 426 and the CPN management 424 comprise components such as a central processing unit 490 coupled to an input output interface 492 for receiving data through wired or wireless data networks. A memory 494 is coupled to the processor 494 executing instructions that can be retrieved from non-volatile storage 496 to execute the associated functions of the respective devices. The instructions stored within the non-volatile storage of the respective device will perform the associated processing authorization and communication functions. The processing functions of the stream management functionality 428 of the data center server 422, are associated with the types of OT device data provided by the associated property. For example video codecs may be provided if video streams are utilized, application programming interfaces (APIs) to access systems such as security, fire, environmental or networking devices can also be provided to access the respective devices and/or convert associated data to a common data schema. The access control devices can also provide Uniform Resource Locator (URL) filter to deliver protection against potentially malicious website in addition to anti-virus and malware management.

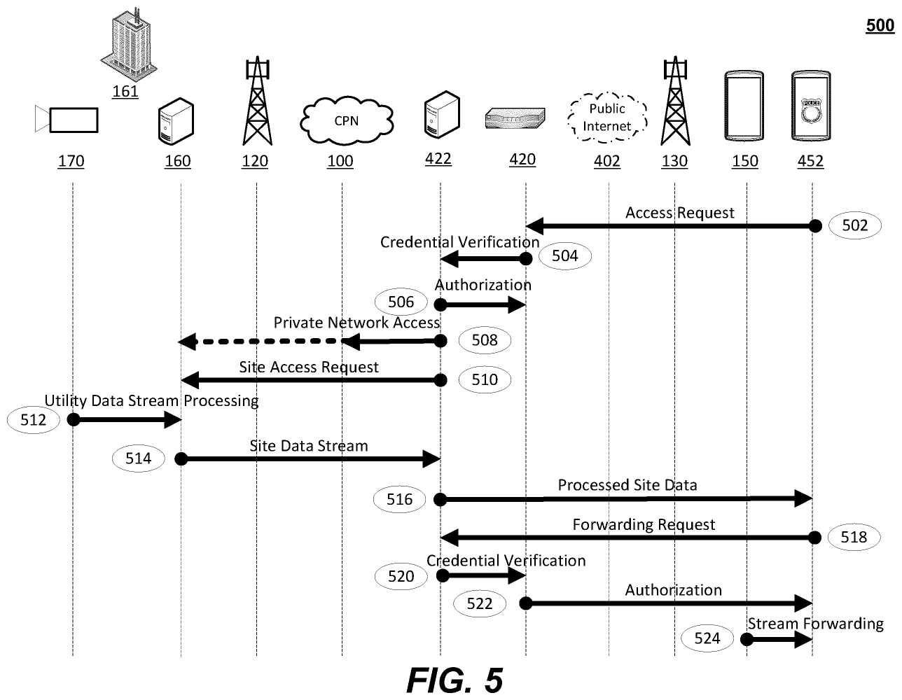

FIG. 5 shows a representation of an exemplary message flow 500 for secure remote connectivity. The client device 150 initiates an request access through a wireless infrastructure 130 coupled to the public Internet 402 (502). The access request is received by the gateway 420 coupled to the public Internet 402. Credentials are verified by server 422 (504). The credentials define a user and a particular property. The authorization may also require the client device 150 to be verified as well. Authorization (506) is provided to the gateway device 420, which may be a separate processing device or defined as a process on the gateway device 420 or server 422. The server 422 establishes a OT device data connection through the CPN 102 with wireless network 100 (508). The access control device 160 receives a site access request (510) to access one or more OT device data associated with devices or systems such as a camera 170 on the property 161.

The OT device such as a camera 170 can then provide a utility device data (512) to the access control device 160 The site OT device data, which can include more than one OT data sources from the site is provided to the CPN management 424 (514) through the secure CPN 102. The OT device data is processed, encrypted and then provided by to the client device 150 through the public network 402 and transported by a virtual private network (VPN) (516). The encryption can utilized one or more encryption techniques such as for example advanced encryption standard (AES), Rivest-Shamir-Adleman (RSA), Triple Data Encryption Algorithm, and Two-Fish or VPN using internet protocol security protocol (IPSec) or generic routing encapsulation (GRE). Alternative encryption schemes may be utilized. The client device 150 can then initiate a forwarding request (518) to provide the site data or a sub-component thereof to another device. The credentials of the client device 150 can be verified to determine that forwarding is allowable (520) and that the target device or emergency service 452 are authorized. Authorization is then provided (522), or may be implicitly provided based upon destination service address, and client device 150 can then forward the stream to the target device emergency services network or device 452 (524). The secure facility OT data may alternatively be imitated by the CPN management 424 directly to the emergency services 152. The authorization may be based upon an identified destination number or network service address, such as 911/999. The ability to forward may be automatically enabled to defined services where as authorization may be required for particular non-emergency services.

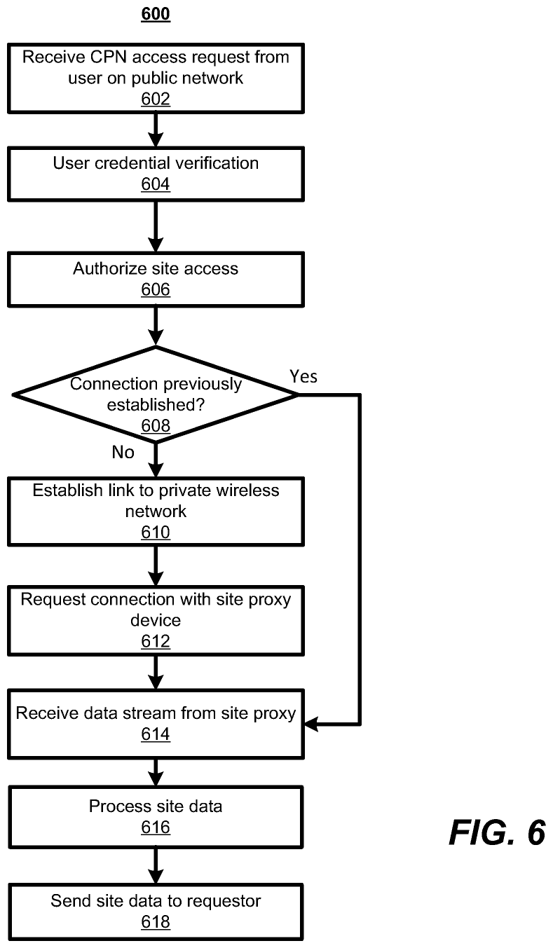

FIG. 6 shows a representation of a method 600 for multilayered secure remote connectivity between networks as performed by the secure utility host service. An access request is received from a client device 150 coupled to a public network (602). The user/device credentials are verified (604). Authorization is then provided to access the OT device data (606). If a link is not pre-existing to the site (No at 608), it is established with the wireless private network (610) and a connection is requested with the site proxy device (612). If a connection is existing (Yes at 608) the OT device data is received from the site (614) and processed for delivery to the device (616) and sent to the requestor device (618).

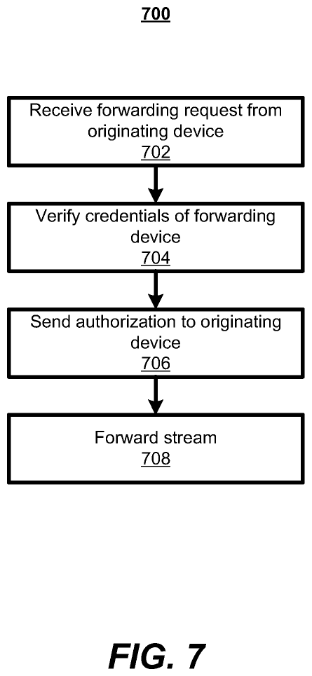

FIG. 7 shows a representation of a method 700 of forwarding OT device data to additional client devices. The process assumes that a connection has already been established with the site and the OT device data is being received by an initial device. The user of the client device may wish to forward or provide access to the OT device data to an emergency services device or platform such as 911. The initial client device can generate a request (702) to the utility gateway identifying where the OT device stream should be forwarded to. The credentials of the requesting device and destination device/service (704) are verified and authorization is provided (706) for the destination device to receive the stream (708). The processing server may initiate the stream to the destinations service with additional filtering, or un-filtering of the content of the data device data based upon the credentials or authorization level of the destination service. The emergency service can then access OT device data to aid in dealing with an emergency situation.

Each element in the embodiments of the present disclosure may be implemented as hardware, software/program, or any combination thereof. Software codes, either in its entirety or a part thereof, may be stored in a computer readable medium or memory (e.g., as a ROM, for example a non-volatile memory such as flash memory, CD ROM, DVD ROM, Blu-ray™, a semiconductor ROM, USB, or a magnetic recording medium, for example a hard disk). The program may be in the form of source code, object code, a code intermediate source and object code such as partially compiled form, or in any other form.

It would be appreciated by one of ordinary skill in the art that the system and components shown in the Figures may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

1. A method for secure access to property operating technology (OT) devices associated with a physical property location, the method comprising:
receiving a request to access OT devices associated with the physical property location from a user device coupled to a public data network;
verifying credentials associated with the user originating the request from the user device;
establishing a secure cellular private network (CPN) connection over a cellular wireless network to an access control device located at the physical property location;
receiving OT device data from the access control device over the secure CPN connection;
encrypting the OT device data received from the access control device; and
forwarding the encrypted OT device data to the user device over the public data network.

2. The method of claim 1 wherein the OT devices is selected from a group comprising access control devices, network video cameras (NVR), heating ventilation and air conditioning (HVAC), elevator monitoring, alarm panels; and building access system.

3. The method of claim 1 wherein the CPN is defined by a subnet on the cellular wireless network.

4. The method of claim 3 wherein the subnet is encrypted.

5. The method of claim 1, the method further comprising:
generating a sharing request from the user device to a subsequent user/service to access data associated with the one or more OT devices;
determining the access rights of the user of the user device;
providing access to the requested OT devices if the user has appropriate access rights or limiting access of the user if they do not have appropriate access rights to the requested OT devices.

6. The method of claim 1 wherein the OT device data is video data, the video data is transcoded prior to encryption.

7. The method of claim 1 wherein the access control device is connected to the cellular network by 3G, 4G LTE or 5G access technologies.

8. The method of claim 1 wherein the CPN is initiated upon a request from the user device.

9. The method of claim 1 wherein a pre-existing CPN is utilized upon a subsequent request from the user device.

10. The method of claim 1 wherein the OT device data is forwarded to an emergency service based upon the request from the user device.

11. The method of claim 10 wherein the emergency service is 911.

12. The method of claim 11 wherein the emergency service is fire, police or ambulance.

13. The method of claim 1 wherein the method is executed at a datacenter coupled to the cellular network.

14. The method of claim 1 wherein the property a commercial office towers, shopping centers, multi-unit residential properties, individual dwellings, government and industrial complexes, utilities, schools and school campuses.

15. The method of claim 1 wherein the encryption is one of AES, DES, RSA, or two-fish encryption schemes.

16. The method of claim 1 wherein the encryption is provided by a virtual private network (VPN).

17. The method of claim 1 wherein the access control device is a site proxy device.

18. A system for secure access to property operating technology (OT) devices associated with a physical property location, the system comprising:
a network data interface coupled to a public wireless network;
a processor coupled to the network data interface;
a memory coupled to the processor, the memory comprising instructions for
receiving a request to access OT devices associated with the physical property location from a user device coupled to a public data network:
verifying credentials associated with the user originating the request from the user device;
establishing a secure cellular private network (CPN) connection over a cellular wireless network to an access control device located at the physical property location;
receiving OT device data from the access control device over the secure CPN connection;
encrypting the OT device data received from the access control device; and
forwarding the encrypted OT device data to the user device over the public data network.

19. (canceled)

20. (canceled)

21. (canceled)

22. (canceled)

23. The method of claim 1 wherein the public data network is a cellular wireless network.

24. A non-transitory computer readable memory containing instructions for secure access to property operating technology (OT) devices associated with a physical property location, the instructions which when executed by a processor perform the method of:
receiving a request to access OT devices associated with the physical property location from a user device coupled to a public data network;
verifying credentials associated with the user originating the request from the user device;
establishing a secure cellular private network (CPN) connection over a cellular wireless network to an access control device located at the physical property location;
receiving OT device data from the access control device over the secure CPN connection;
encrypting the OT device data received from the access control device; and
forwarding the encrypted OT device data to the user device over the public data network.
